(19) United States
(12) Patent Application Publication
(10) Pub. No.: US 2009/0109203 A1
(43) Pub. Date: Apr. 30, 2009

(54) Liquid Crystal Display Device and Method for Driving the Same

(76) Inventors: Hajime Washio, Oxford (GB); Michael James Brownlow, Oxfordshire (GB)

Correspondence Address: HARNESS, DICKEY & PIERCE, P.L.C., P.O. BOX 8910, RESTON, VA, 20195, US

(21) Appl. No.: 12/084,763

(22) PCT Filed: Sep. 25, 2006
(86) PCT No.: PCT/JP2006/318957

§ 371 Date: May 9, 2008

(30) Foreign Application Priority Data
Nov. 16, 2005 (JP) 2005-331483

(51) Int. Cl. G09G 5/00; G09G 3/36

(52) U.S. Cl. 345/208; 345/87; 348/791

(57) ABSTRACT

A data signal line drive circuit is provided with first sampling portions, and second sampling portions operated at a lower speed. By the action of selection circuits, the first sampling portions are operated during a normal display mode, and the second sampling portions are operated during a partial display mode. To ensure a correct sampling operation, one line time and a sampling interval are rendered longer during a display period of the partial display mode than during the normal display mode. During the normal display mode, both the first sampling portions and the second sampling portions may be operated. Thus, power consumption of a liquid crystal display device during the partial display is reduced.

### TECHNICAL FIELD

The present invention relates to liquid crystal display devices, and methods for driving the same, and particularly to a liquid crystal display device with a partial display function, and a method for driving the same.

### BACKGROUND ART

Some liquid crystal display devices have the function of effecting a display on a portion of the screen (hereinafter, referred to as a “partial display”). The partial display is used in, for example, cell phones to display the radio wave reception status or time on a portion of the screen during standby mode (see FIG. 10). When effecting the partial display, a video signal is written to display elements within a prescribed display area(s), but not to any display elements within a non-display area(s). By effecting such a partial display, it becomes possible to decrease the frequency of driving the display elements, thereby reducing power consumption of the liquid crystal display device. The partial display is disclosed in, for example, Patent Documents 1 and 2.

FIG. 11 is a diagram illustrating the configuration of a conventional liquid crystal display device with the partial display function. In FIG. 11, a pixel array 84 includes (m×n) display elements P, n scanning signal lines G1 to Gn, and m data signal lines S1 to Sm. A scanning signal line drive circuit 82 sequentially selects and activates the scanning signal lines G1 to Gn based on control signals (GSP, GEN, GCK1, and GCK2) outputted from a display control portion 81. A data signal line drive circuit 83 drives the data signal lines S1 to Sm based on control signals (SSP, SCK, and SCKB) and a video signal VD, which are outputted from the display control portion 81.

When effecting the partial display, the display control portion 81 controls the gate enable signal GEN to be at low level during any non-display period (a period corresponding to the non-display area). The scanning signal line drive circuit 82 does not activate any scanning signal lines when the gate enable signal GEN is at low level. Accordingly, while the gate enable signal GEN is at low level, the video signal VD is not written to any display elements P.

FIG. 12 is a diagram illustrating a detailed configuration of the data signal line drive circuit 83. The data signal line drive circuit 83 includes flip-flops 91 and sampling portions 92 in association with their respective data signal lines S1 to Sm. The flip-flops 91 are connected in a series to form a shift register. Output signals of the shift register act as sampling signals SMP1 to SMPm for the data signal lines S1 to Sm.

The sampling portions 92 each include a plurality of inverters 93 and one sampling switch 94. The inverters 93 are connected in a series in ascending order of their drive capabilities. The sampling switch 94 has control terminals to which is supplied any one of the sampling signals SMP1 to SMPm that has passed through the inverters 93. The sampling switch 94 alternates between applying and not applying the video signal VD to any one of the data signal lines S1 to Sm based on the sampling signal supplied to the control terminals. Note that the reason for providing the inverters 93 in the sampling portion 92 is that the drive capability of the flip-flop 91 is not sufficient to operate the sampling switch 94 at a desired speed.

[Patent Document 1] Japanese Laid-Open Patent Publication No. 11-184434

[Patent Document 2] Japanese Laid-Open Patent Publication No. 2002-99262

### DISCLOSURE OF THE INVENTION

### Problems To Be Solved By The Invention

The above-described partial display is mainly effected in electronic equipment with severe power consumption requirements (e.g., cell phones). Therefore, power consumption of the liquid crystal display devices also needs to be reduced as much as possible. On the other hand, however, the number of display elements to be included in the liquid crystal display devices has been increasing. As the number of display elements increases, power consumption of the liquid crystal display devices also increases for reasons such as (1) increase in number of sampling portions, and (2) higher operational speed of the sampling portions.

Incidentally, when the liquid crystal display devices with the partial display function are used, in general, the time period in which to effect the partial display is considerably longer compared to the time period in which to effect a display on the entire screen. Accordingly, reduction in power consumption during the partial display is effective in reducing power consumption of the liquid crystal display devices. In addition, as for the data signal line drive circuits of the liquid crystal display devices, it is known that buffer circuits (in FIG. 11, the inverters 93) provided between the shift register and the sampling switches consume significant power.

Therefore, an objective of the present invention is to reduce power consumption of the liquid crystal display devices during the partial display.

### Solution To The Problems

A first aspect of the present invention is directed to a liquid crystal display device with a partial display function, comprising:

a pixel array including a plurality of display elements disposed in row and column directions, a plurality of scanning signal lines, each being commonly connected to the display elements disposed in the same row, and a plurality of data signal lines, each being commonly connected to the display elements disposed in the same column;

a scanning signal line drive circuit for selectively activating the scanning signal lines; and

a data signal line drive circuit for driving the data signal lines based on a supplied video signal,

wherein the data signal line drive circuit includes:

a shift register for outputting a sampling signal to each of the data signal lines;

selection circuits each having first and second output terminals to output the sampling signal outputted from the shift register at least from the first output terminal during a normal display mode, and from the second output terminal during a partial display mode;

first sampling portions each sampling the video signal based on the sampling signal outputted from the first output terminal for application to the data signal line; and

second sampling portions each sampling the video signal based on the sampling signal outputted from the second output terminal for application to the data signal line.

In a second aspect of the present invention, based on the first aspect of the invention, the second sampling portions have such a circuit configuration as to be operated at a lower speed than the first sampling portions.

In a third aspect of the present invention, based on the second aspect of the invention, the first sampling portions each include:

a first buffer portion to which the sampling signal outputted from the first output terminal is inputted; and

a first sampling switch alternating between applying and not applying the video signal to the data signal line based on the sampling signal outputted from the first buffer portion,

the second sampling portions each include:

a second buffer portion to which the sampling signal outputted from the second output terminal is inputted; and

a second sampling switch alternating between applying and not applying the video signal to the data signal line based on the sampling signal outputted from the second buffer portion,

the second buffer portion has a lower drive capability than the first buffer portion, and

the second sampling switch has a higher on-resistance than the first sampling switch.

In a fourth aspect of the present invention, based on the third aspect of the invention, the second buffer portion is configured by transistors with a narrower channel width than those of the first buffer portion, and

the second sampling switch is configured by transistors with a narrower channel width than those of the first sampling switch.

In a fifth aspect of the present invention, based on the first aspect of the invention, during the normal display mode, the selection circuits each output the sampling signal outputted from the shift register from the first output terminal, but not from the second output terminal.

In a sixth aspect of the present invention, based on the first aspect of the invention, during the normal display mode, the selection circuits each output the sampling signal outputted from the shift register from both the first and second output terminals.

In a seventh aspect of the present invention, based on the first aspect of the invention, the scanning signal line drive circuit switches any scanning signal line to be activated every first line time during the normal display mode, while switching the scanning signal line to be activated every second line time longer than the first line time during a display period of the partial display mode, and

the shift register is operated at first sampling intervals during the normal display mode, and at second sampling intervals longer than the first sampling intervals during the display period of the partial display mode.

An eighth aspect of the present invention is directed to a method for driving a liquid crystal display device having a pixel array including a plurality of display elements disposed in row and column directions, a plurality of scanning signal lines, each being commonly connected to the display elements disposed in the same row, and a plurality of data signal lines, each being commonly connected to the display elements disposed in the same column, the method comprising the steps of:

selectively activating the scanning signal lines; and

driving the data signal lines based on a supplied video signal,

wherein the step of driving the data signal lines includes the steps of:

generating a sampling signal for each of the data signal lines;

outputting the generated sampling signal at least as a first sampling signal during a normal display mode, and as a second sampling signal during a partial display mode;

sampling the video signal based on the first sampling signal using a first sampling portion for application to the data signal line; and

sampling the video signal based on the second sampling signal using a second sampling portion for application to the data signal line.

### EFFECT OF THE INVENTION

According to the first or eighth aspect of the present invention, the first sampling portions (or both the first and second sampling portions) are used for sampling during the normal display mode, while the second sampling portions different from the first sampling portions are used for sampling during the partial display mode. Thus, it is possible to reduce power consumption during the partial display compared to conventional liquid crystal display devices.

According to the second aspect of the present invention, The first sampling portions (or both the first and second sampling portions) are used for sampling during the normal display mode, while the second sampling portions operated at a lower speed than the first sampling portions are used for sampling during the partial display mode. Thus, it is possible to reduce power consumption during the partial display compared to conventional liquid crystal display devices.

According to the third aspect of the present invention, the first sampling portions and the second sampling portions differ in characteristics of their buffer portions and sampling switches, and therefore it is possible to obtain a liquid crystal display device provided with the second sampling portions operated at a lower speed than the first sampling portions.

According to the fourth aspect of the present invention, the first sampling portions and the second sampling portions differ in channel width of the transistors included in their buffer portions and sampling switches, and therefore it is possible to obtain a liquid crystal display device provided with the second sampling portions operated at a lower speed than the first sampling portions.

According to the fifth aspect of the present invention, the first sampling portions and the second sampling portions are always operated exclusively of each other, and therefore it is possible to facilitate design and evaluation of the liquid crystal display device.

According to the sixth aspect of the present invention, two sampling portions are operated in parallel during the normal display mode, and therefore it is possible to design such first sampling portions with reduced performance.

According to the seventh aspect of the present invention, during the display period of the partial display mode, one line time and the sampling intervals are rendered longer than during the normal display mode, so that the video signal changes at a lower speed than during the normal display mode. Thus, it is possible to ensure a correct sampling operation even during the partial display mode in which the second sampling portions are operated.

### BRIEF DESCRIPTION OF THE DRAWINGS

FIG. 1 is a block diagram illustrating the configuration of a liquid crystal display device according to an embodiment of the present invention.

FIG. 2 is a diagram illustrating a detailed configuration of a data signal line drive circuit included in the liquid crystal display device shown in FIG. 1.

FIG. 3A is a circuit diagram for a first exemplary configuration of a selection circuit included in the data signal line drive circuit shown in FIG. 2.

FIG. 3B is a diagram illustrating a truth table for the selection circuit shown in FIG. 3A.

FIG. 4A is a circuit diagram for a second exemplary configuration of the selection circuit included in the data signal line drive circuit shown in FIG. 2.

FIG. 4B is a diagram illustrating a truth table for the selection circuit shown in FIG. 4A.

FIG. 5A is a circuit diagram for a third exemplary configuration of the selection circuit included in the data signal line drive circuit shown in FIG. 2.

FIG. 5B is a diagram illustrating a truth table for the selection circuit shown in FIG. 5A.

FIG. 6 is a timing chart for the data signal line drive circuit including the selection circuit shown in FIG. 3A or 4A.

FIG. 7 is a timing chart for the data signal line drive circuit including the selection circuit shown in FIG. 5A.

FIG. 8 is a table showing operational statuses of first and second sampling portions included in the data signal line drive circuit shown in FIG. 2.

FIG. 9 is a timing chart for output signals of display control portion included in the liquid crystal display device shown in FIG. 1.

FIG. 10 is a diagram illustrating an exemplary display screen by a partial display.

FIG. 11 is a block diagram illustrating the configuration of a conventional liquid crystal display device.

FIG. 12 is a diagram illustrating a detailed configuration of a data signal line drive circuit included in the conventional liquid crystal display device.

### DESCRIPTION OF THE REFERENCE CHARACTERS

10 liquid crystal display device

11 display control portion

12 scanning signal line drive circuit

13 data signal line drive circuit

14 pixel array

21 flip-flop

22 selection circuit

23 first sampling portion

24 second sampling portion

31, 41 inverter

32, 42 sampling switch

### BEST MODE FOR CARRYING OUT THE INVENTION

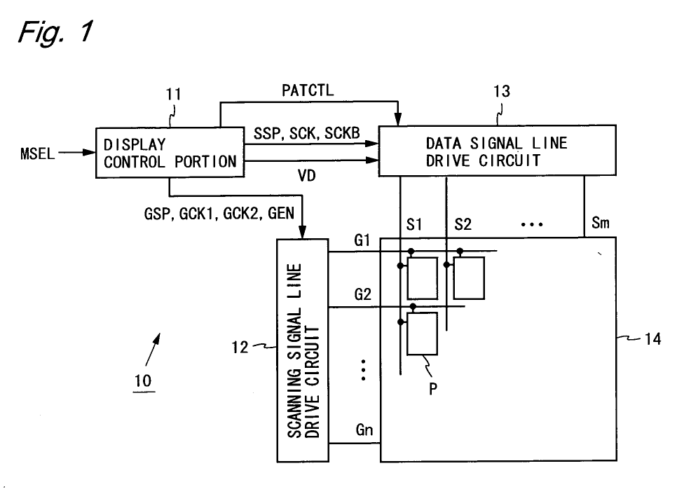

FIG. 1 is a block diagram illustrating the configuration of a liquid crystal display device according to an embodiment of the present invention. The liquid crystal display device 10 shown in FIG. 1 includes a display control portion 11, a scanning signal line drive circuit 12, a data signal line drive circuit 13, and a pixel array 14. Supplied to the liquid crystal display device 10 is a mode selection signal MSEL specifying a normal display mode or a partial display mode. The liquid crystal display device 10 effects a display on the entire screen during the normal display mode, while effecting a display on a portion of the screen during the partial display mode.

The pixel array 14 includes (m×n) display elements P, n scanning signal lines G1 to Gn, and m data signal lines S1 to Sm. The (m×n) display elements P are disposed, m each for the row direction, and n each for the column direction. The scanning signal lines G1 to Gn are each commonly connected to the display elements P disposed in the same row. The data signal lines S1 to Sm are each commonly connected to the display elements P disposed in the same column.

The pixel array 14 is formed on a liquid crystal panel. All or part of the scanning signal line drive circuit 12 and the data signal line drive circuit 13 are monolithically formed on the liquid crystal panel. In addition, part of the display control portion 11 may also be monolithically formed on the liquid crystal panel.

The display control portion 11 outputs control signals to the scanning signal line drive circuit 12 and the data signal line drive circuit 13, and also outputs a video signal VD to the data signal line drive circuit 13. More specifically, the display control portion 11 outputs a gate start pulse GSP, gate clocks GCK1 and GCK2, and a gate enable signal GEN to the scanning signal line drive circuit 12, and also outputs a source start pulse SSP, source clocks SCK and SCKB (a negative signal of SCK), a partial display control signal PATCTL, and the video signal VD to the data signal line drive circuit 13.

The gate start pulse GSP is a signal indicating the Head of one frame, and is set at a predetermined level (hereinafter, described as high level) for a predetermined period of time at the rate of once per frame time. The gate clocks GCK1 and GCK2 are signals each indicating the head of one line, and each change to a predetermined direction (hereinafter, described as a rising direction) at the rate of once every two line times. The gate enable signal GEN is a signal indicating per line whether to effect display, and is set at a predetermined value (hereinafter, described as high level) during the normal display mode, and during any display period (a period corresponding to a display area) of the partial display mode.

An interval at which the video signal VD changes is referred to below as a “cycle”. The source start pulse SSP is a signal indicating the head of one line, and is set at a predetermined level (hereinafter, described as high level) for one cycle every line time. The source clock SCK is a clock signal having an interval of two cycles. The partial display control signal PATCTL is the same signal as the mode selection signal MSEL. The video signal VD changes in synchronization with the rise and fall of the source clock SCK.

The scanning signal line drive circuit 12 sequentially selects and activates the scanning signal lines G1 to Gn based on the control signals outputted from the display control portion 11. More specifically, the scanning signal line drive circuit 12 activates the scanning signal line G1 for one line time immediately after the gate start pulse GSP is outputted, by applying a predetermined potential to the scanning signal line G1. Thereafter, each time the gate clock GCK1 or GCK2 rises, the scanning signal line drive circuit 12 switches the scanning signal line to be activated in the order: G2, G3, . . . , Gn. However, when the gate enable signal GEN is at low level, the scanning signal line drive circuit 12 does not activate any scanning signal line.

The data signal line drive circuit 13 drives the data signal lines S1 to Sm based on the control signals and the video signal VD outputted from the display control portion 11. The data signal line drive circuit 13 has a circuit configuration as described below.

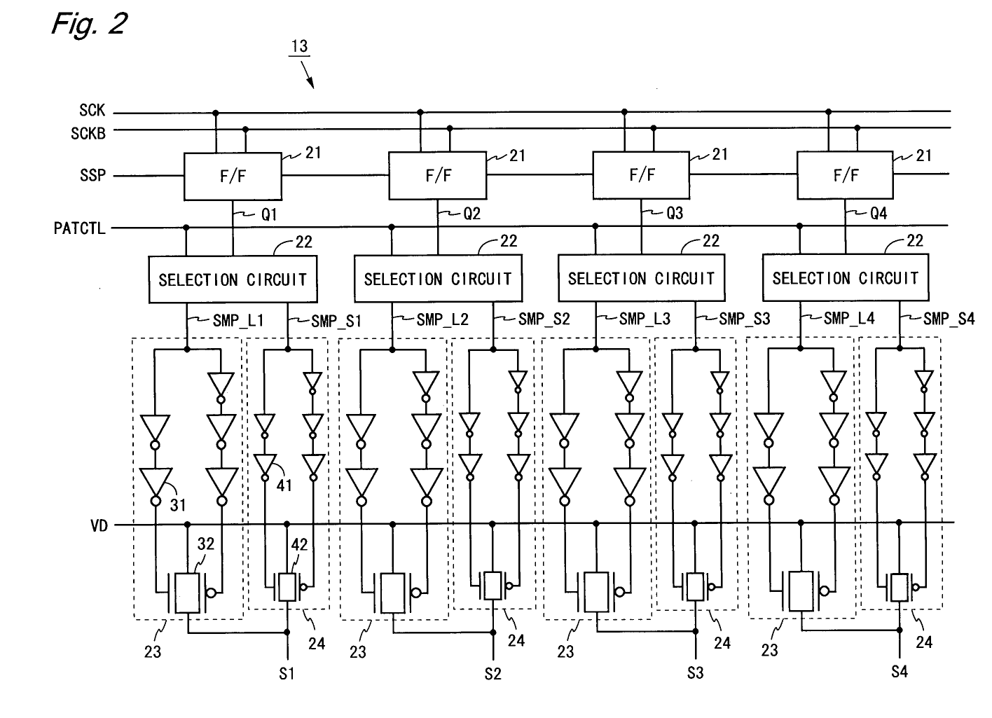

FIG. 2 is a diagram illustrating a detailed configuration of the data signal line drive circuit 13. The data signal line drive circuit 13 includes flip-flops 21, selection circuits 22, first sampling portions 23, and second sampling portions 24 in association with their respective data signal lines S1 to Sm. Note that for simplification of the figure, only the circuits associated with the data signal lines S1 to S4 are depicted in FIG. 2.

The data signal line drive circuit 13 includes m flip-flops 21 in total. The m flip-flops 21 are connected in a series to form an m-stage shift register, such that an output from a previous stage is inputted to the next stage. The source clocks SCK and SCKB, and the source start pulse SSP are supplied to the shift register, respectively, as clock inputs, and a serial data input. When the source clock SCK or SCKB changes, the flip-flops 21 each memorize an output signal of the flip-flop 21 in the previous stage (or the source start pulse SSP).

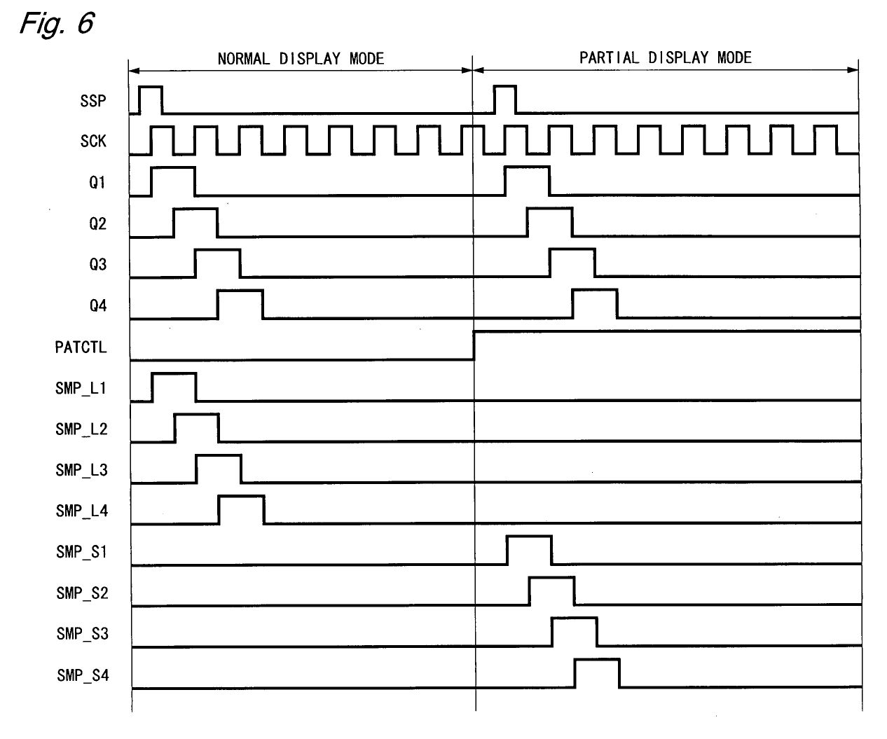

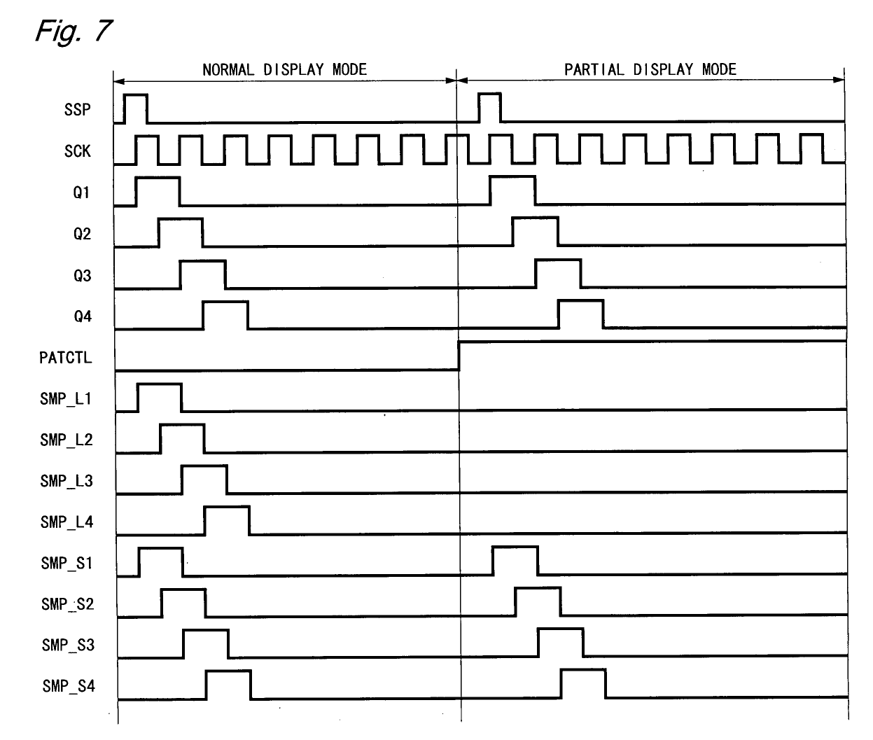

The output signal of the i'th (where i is an integer from 1 to m) flip-flop 21 is referred to below as the sampling signal Qi. The sampling signal Q1 is initially set at high level for two cycles during one line time. The sampling signal Q2 is set at high level for two cycles, with a delay of one cycle from the rise of the sampling signal Q1. Similarly, the sampling signal Qi is set at high level for two cycles, with a delay of one cycle from the rise of the sampling signal Qi-1 (see FIGS. 6 and 7 to be described later).

The selection circuits 22, the first sampling portions 23, and the second sampling portions 24, which are provided in association with their respective data signal lines S1 to Sm, each discretely have the same circuit configuration. The selection circuit 22, the first sampling portion 23, and the second sampling portion 24 provided in association with the data signal line Si will be described below.

The sampling signal Qi and the partial display control signal PATCTL are inputted to the selection circuit 22. The partial display control signal PATCTL is set at low level during the normal display mode, and high level during the partial display mode. The selection circuit 22 has a first output terminal connected to the first sampling portion 23, and a second output terminal connected to the second sampling portion 24. The selection circuit 22 outputs the sampling signal Qi from the first output terminal during the normal display mode, while outputting the sampling signal Qi from the second output terminal during the partial display mode. Alternatively, the selection circuit 22 may output the sampling signal Qi from both the first and second output terminals during the normal display mode.

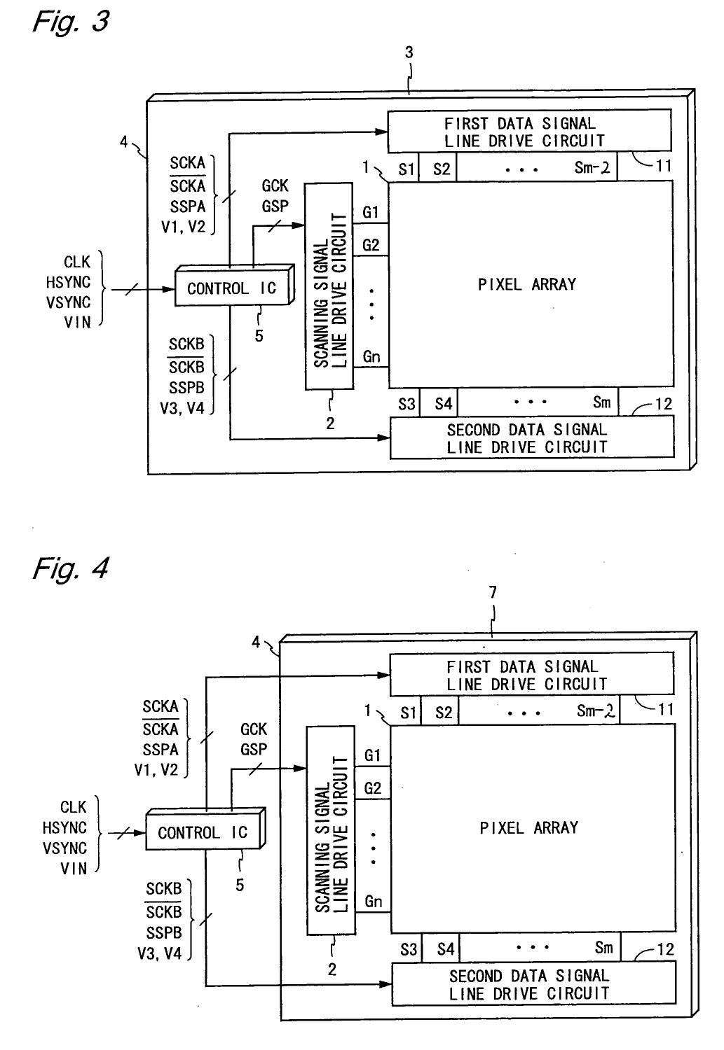

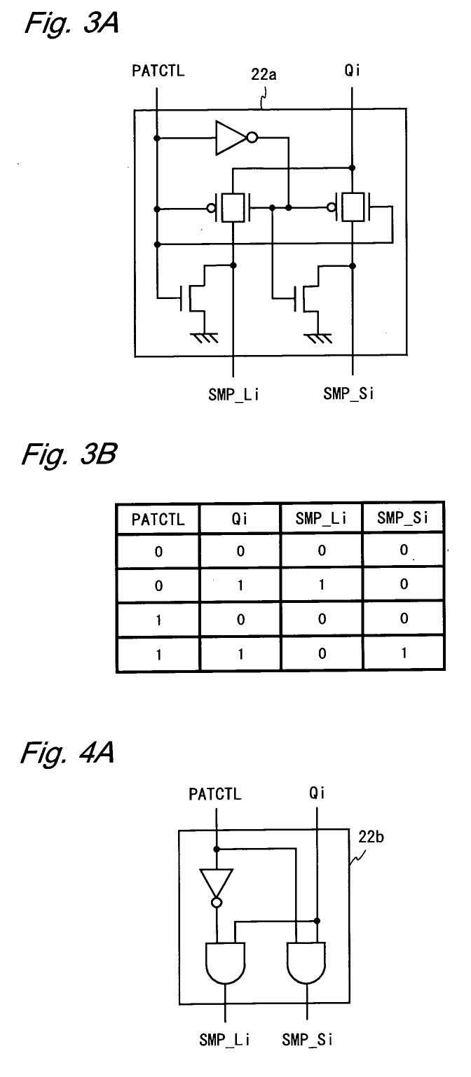

FIGS. 3A, 4A, and 5A are circuit diagrams, respectively, for first to third exemplary configurations of the selection circuit 22, and FIGS. 3B, 4B, and 5B are diagrams respectively illustrating truth tables for the selection circuits shown in FIGS. 3A, 4A, and 5A. Hereinafter, the sampling signal outputted from the first output terminal of the selection circuit 22 is referred to as the first sampling signal SMP_Li, and the sampling signal outputted from the second output terminal of the selection circuit 22 is referred to as the second sampling signal SMP_Si.

The selection circuit 22a shown in FIG. 3A includes one inverter, two analog switches, and two N-type MOS transistors. The selection circuit 22a outputs the sampling signal Qi from the first output terminal when the partial display control signal PATCTL is at low level, while outputting the sampling signal Qi from the second output terminal when the partial display control signal PATCTL is at high level (see FIG. 3B).

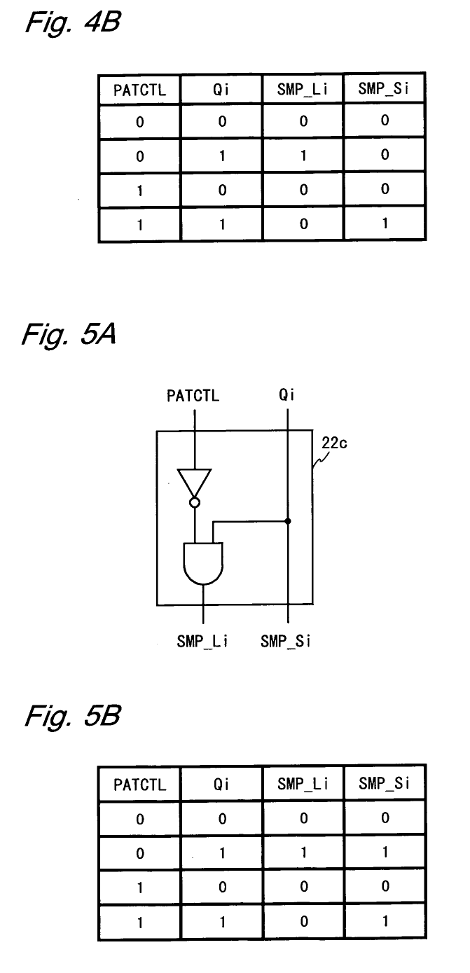

The selection circuit 22b shown in FIG. 4A includes one inverter, and two AND gates. Similar to the selection circuit 22a, the selection circuit 22b outputs the sampling signal Qi from the first output terminal when the partial display control signal PATCTL is at low level, while outputting the sampling signal Qi from the second output terminal when the partial display control signal PATCTL is at high level (see FIG. 4B).

The selection circuit 22c shown in FIG. 5A includes one inverter, and one AND gate. The selection circuit 22c outputs the sampling signal Qi from both the first and second output terminals when the partial display control signal PATCTL is at low level, while outputting the sampling signal Qi from the second output terminal when the partial display control signal PATCTL is at high level (see FIG. 5B).

FIG. 6 is a timing chart for the data signal line drive circuit 13 including the selection circuit 22a or 22b. During the normal display mode (when the partial display control signal PATCTL is at low level), the first sampling signal SMP_Li is outputted based on the sampling signal Qi, as shown in FIG. 6. During the partial display mode (when the partial display control signal PATCTL is at high level), the second sampling signal SMP_Si is outputted based on the sampling signal Qi.

FIG. 7 is a timing chart for the data signal line drive circuit 13 including the selection circuit 22c. During the normal display mode, the first sampling signal SMP_Li and the second sampling signal SMP_Si are outputted based on the sampling signal Qi, as shown in FIG. 7. During the partial display mode, the second sampling signal SMP_Si is outputted based on the sampling signal Qi.

The first sampling portion 23 samples the video signal VD based on the first sampling signal SMP_Li for application to the data signal line Si. The second sampling portion 24 samples the video signal VD based on the second sampling signal SMP_Si for application to the data signal line Si.

As described above, the selection circuit 22 switches the destination of the sampling signal Qi depending on the partial display control signal PATCTL. Accordingly, the first sampling portion 23 and the second sampling portion 24 may or may not be operated depending on the type of the selection circuit 22, and the partial display control signal PATCTL.

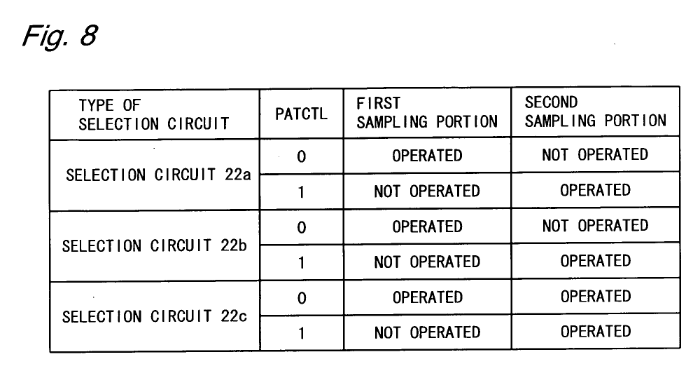

FIG. 8 is a table showing operational statuses of the first sampling portion 23 and the second sampling portion 24. In the case of using the selection circuit 22a or 22b as the selection circuit 22, the first sampling portion 23 is operated when the partial display control signal PATCTL is at low level, and the second sampling portion 24 is operated when the partial display control signal PATCTL is at high level, as shown in FIG. 8. In addition, in the case of using the selection circuit 22c as the selection circuit 22, the first sampling portion 23 and the second sampling portion 24 are operated when the partial display control signal PATCTL is at low level, and the second sampling portion 24 is operated when the partial display control signal PATCTL is at high level.

Referring again to FIG. 2, the first sampling portion 23 and the second sampling portion 24 will be described in detail below. The first sampling portion 23 includes a plurality of inverters 31 and one sampling switch 32, as shown in FIG. 2. The sampling switch 32 is an analog switch consisting of a P-type MOS transistor and an N-type MOS transistor. The video signal VD is supplied to one conductive terminal of the sampling switch 32, and the other conductive terminal thereof is connected to the data signal line Si.

The inverters 31 are separated into two groups, such that the inverters 31 in each group are connected in a series. The inverters 31 connected in a series function as a buffer portion. More specifically, the inverters 31 are connected in ascending order of the channel widths of their internal MOS transistors (i.e., in ascending order of their drive capabilities) Inputted to the first inverter 31 is the first sampling signal SMP_Li. Supplied to the control terminals of the sampling switch 32 is the first sampling signal SMP_Li that has passed through the last inverters 31. Note that the first sampling portion 23 may include other circuits with the buffer function (e.g., buffers for outputting input signals without inversion), in place of the inverters 31.

When the first sampling signal SMP_Li is at high level, the sampling switch 32 is in ON state, so that the video signal VD is applied to the data signal line Si. On the other hand, when the first sampling signal SMP_Li is at low level, the sampling switch 32 is in OFF state, so that no video signal VD is applied to the data signal line Si. As such, the sampling switch 32 alternates between applying and not applying the video signal VD to the data signal line Si based on the sampling signal supplied to the control terminals (the first sampling signal SMP_Li that has passed through the buffers 31).

Similar to the first sampling portion 23, the second sampling portion 24 includes a plurality of inverters 41 and one sampling switch 42. The form of connection between the inverters 41 and the sampling switch 42 is the same as in the first sampling portion 23. The inverters 41 connected in a series function as a buffer portion. The sampling switch 42 alternates between applying and not applying the video signal VD to the data signal line Si based on the second sampling signal SMP_Si that has passed through the inverters 41.

The second sampling portion 24 differs from the first sampling portion 23 in the following points. The sampling switch 42 is configured using MOS transistors with a narrower channel width than those of the sampling switch 32. Therefore, the sampling switch 42 has a higher on-resistance than the sampling switch 32. In addition, the inverters 41 are configured using MOS transistors with a narrower channel width than those of the inverters 31. Therefore, the inverters 41 each have a lower drive capability than the inverters 31, so that the buffer circuit configured by the inverters 41 has a lower drive capability than the buffer circuit configured by the inverters 31. Due to the above differences in circuit configuration, the second sampling portion 24 is operated at a lower speed than the first sampling portion 23.

As described above, during the partial display mode, the first sampling portion 23 is not operated, and only the second sampling portion 24 is operated (see FIG. 8). To ensure a correct sampling operation during such a partial display mode, the liquid crystal display device 10 employs a method as described below, in which one line time and sampling intervals are rendered longer during the display period of the partial display mode than during the normal display mode, and one line time is rendered shorter during the non-display period of the partial display mode than during the normal display mode.

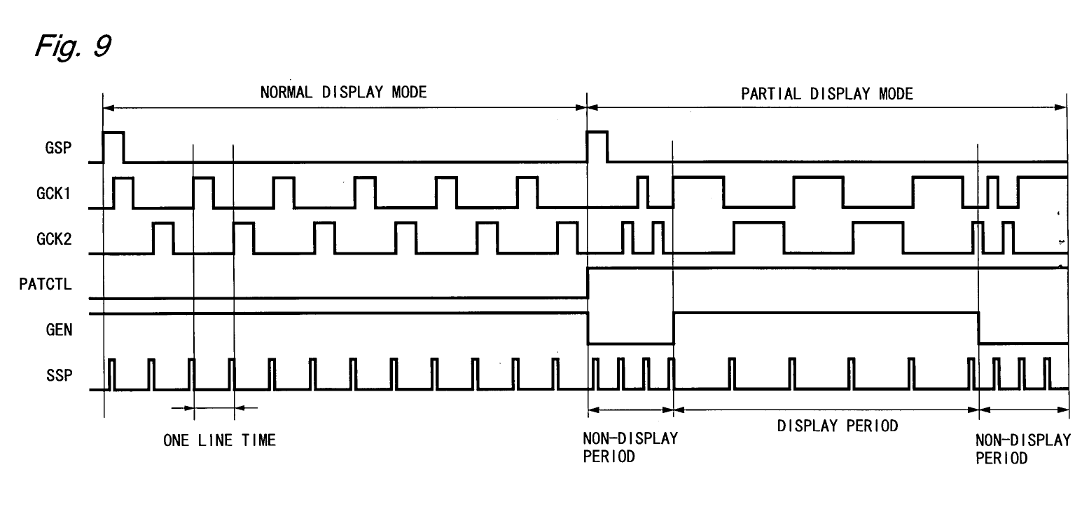

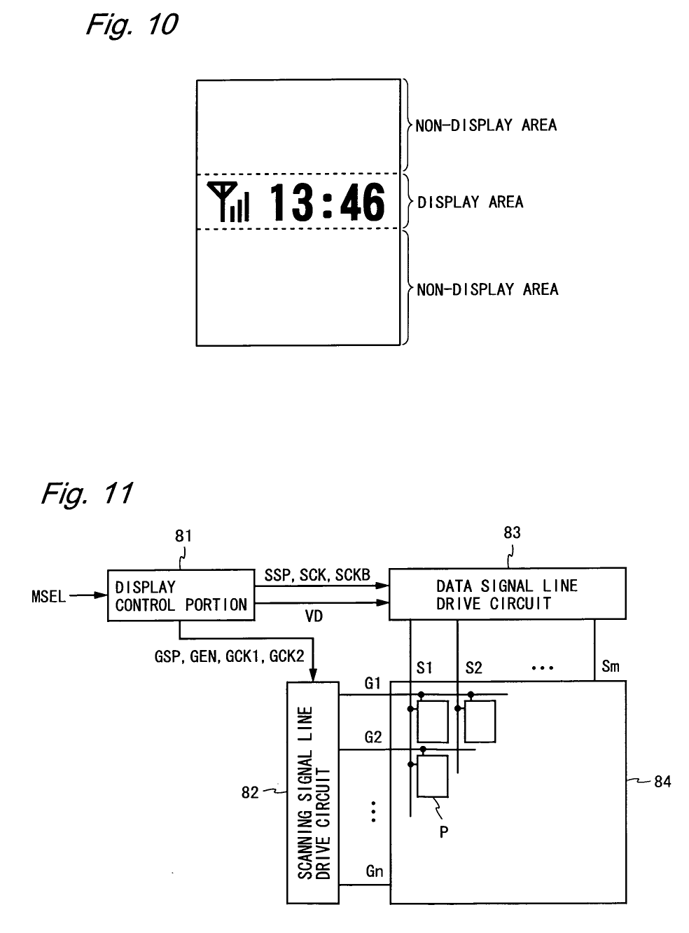

FIG. 9 is a timing chart for the output signals of the display control portion 11. During the normal display mode (when the partial display control signal PATCTL is at low level), the gate clock GCK1 or GCK2 rises every line time (hereinafter, denoted by T1). Therefore, the scanning signal line drive circuit 12 switches the scanning signal line to be activated every line time T1.

On the other hand, during the display period of the partial display mode (when the partial display control signal PATCTL is at high level, and the gate enable signal GEN is at high level), the gate clock GCK1 or GCK2 rises every line time (hereinafter, denoted by T2) longer than the line time T1 (one line time during the normal display mode). Therefore, the scanning signal line drive circuit 12 switches the scanning signal line to be activated every line time T2 longer than the line time T1.

In addition, during the non-display period of the partial display mode (when the partial display control signal PATCTL is at high level, and the gate enable signal GEN is at low level), the gate clock GCK1 or GCK2 rises every line time (hereinafter, denoted by T3) shorter than the line time T1. However, the gate enable signal GEN is at low level, and therefore the scanning signal line drive circuit 12 does not activate any scanning signal line.

As such, one line time in the liquid crystal display device 10 is T1 during the normal display mode, T2 (T2>T1) during the display period of the partial display mode, and T3 (T3<T1) during the non-display period of the partial display mode (hereinafter, such a time period is denoted by T0). One line time T0 is the basis of times at which to change the source start pulse SSP, the source clocks SCK and SCKB, and the video signal VD. The length of one cycle that corresponds to the interval at which the video signal VD changes and is equivalent to half the interval of the source clock SCK is determined based on one line time T0.

Therefore, the length of one cycle is longer during the display period of the partial display mode than during the normal display mode. Accordingly, during the display period of the partial display mode, the shift register composed of the flip-flops 21 is operated at a lower speed (at T1/T2 times speed) compared to during the normal display mode. In other words, the flip-flops are operated at first sampling intervals during the normal display mode, and at second sampling intervals longer than the first sampling intervals during the partial display mode. In addition, during the display period of the partial display mode, the video signal VD changes at a lower speed (at T1/T2 times speed) compared to during the normal display mode.

Note that even when the length of one line time is changed as described above, the length of one frame time is maintained constant. Accordingly, for example, when the display area contains “a” rows of display elements, the following equation (1) is established.

T1×n=T2×a+T3×(n−a) (1)

In addition, the gate enable signal GEN is at low level during the non-display period of the partial display mode, and therefore no video signal VD is written to any display elements P. Accordingly, even if one line time T3 during the non-display Period of the partial display mode is shorter than one line time T1 during the normal display mode, the screen display is not disrupted.

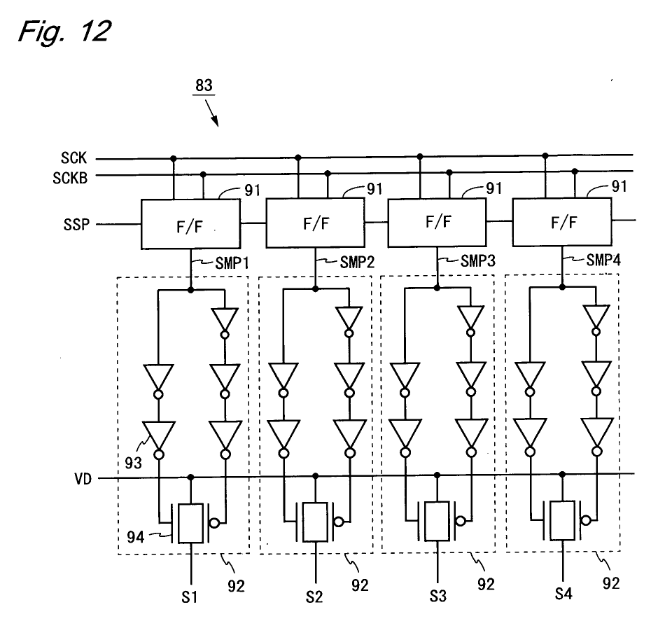

Effects of the liquid crystal display device 10 according to the present embodiment will be described below. In the case of the conventional liquid crystal display device (see FIGS. 11 and 12), the data signal line drive circuit 83 is operated in the same manner both during the normal display mode and during the partial display mode. Accordingly, power consumption of the data signal line drive circuit 83 is the same both during the normal display mode and during the partial display mode.

In the case of the liquid crystal display device 10 (see FIGS. 1 and 2), on the other hand, the first sampling portions 23 (or both the first sampling portions 23 and the second sampling portions 24) are operated during the normal display mode, while the second sampling portions 24 are operated during the partial display mode. In the first sampling portions 23, the sampling switch 32 consumes little power, but the inverters 31 consume power in accordance with changes of the sampling signal Qi. Also, in the second sampling portions 24, the sampling switch 42 consumes little power, but the inverters 41 consume power in accordance with changes of the sampling signal Qi.

However, the inverters 41 are configured using MOS transistors with a narrower channel width than those of the inverters 31, and therefore the inverters 41 consume less power than the inverters 31. Thus, the second sampling portions 24 consume less power than the first sampling portions 23.

As such, in the case of the liquid crystal display device 10, the second sampling portions 24, which consume less power than the first sampling portions 23, are operated during the partial display mode. Thus, the liquid crystal display device 10 makes it possible to reduce power consumption during the partial display compared to the conventional liquid crystal display device.

Also, in the case of the liquid crystal display device 10, one line time and the sampling intervals are rendered longer during the display period of the partial display mode than during the normal display mode, so that the video signal VD changes at a lower speed than during the normal display mode. Thus, it is possible to ensure a correct sampling operation even during the partial display mode in which only the second sampling portions 24 are operated.

Particularly, by using the selection circuit 22 that outputs the sampling signal Qi to the first sampling portion 23 but not to the second sampling portion 24 during the normal display mode, such as the selection circuit 22a or 22b, the first sampling portion 23 and the second sampling portion 24 are always operated exclusively of each other, and therefore it is possible to facilitate design and evaluation of the liquid crystal display device 10.

In addition, by using the selection circuit 22 that outputs the sampling signal Qi to both the first sampling portion 23 and the second sampling portion 24 during the normal display mode, such as the selection circuit 22c, the two sampling portions are operated in parallel during the normal display mode, and therefore it is possible to design such first sampling portion 23 with reduced performance.

Note that by suitably designing the display control portion 11, it becomes possible to configure liquid crystal display devices as described below. A first liquid crystal display device may have a smaller frame rate (the number of frames per unit time) during the partial display mode than during the normal display mode. A second liquid crystal display device may be such that, during the partial display mode, the video signal is written to the display elements within the display area at predetermined time intervals, and to the display elements within the non-display area at longer time intervals. A third liquid crystal display device may provide a screen display based on a multi-value video signal during the normal display mode, while providing a screen display based on a binary video signal during the partial display mode. In this case, the liquid crystal display device may use an operational amplifier to generate the multi-value video signal, or a switch connected to two types of supply voltages to generate the binary video signal. These liquid crystal display devices make it possible to further reduce power consumption during the partial display.

As described above, the liquid crystal display device according to the present embodiment uses the first sampling portions (or both the first and second sampling portions) for sampling during the normal display mode, and uses the second sampling portions different from the first sampling portions for sampling during the partial display mode. Thus, the liquid crystal display device according to the present embodiment makes it possible to reduce power consumption during the partial display compared to the conventional liquid crystal display device.

### INDUSTRIAL APPLICABILITY

The liquid crystal display device of the present invention has the effect of reducing power consumption during the partial display, and therefore can be used as a display device in various apparatuses, such as cell phones, information-processing terminals, and personal computers.

1. A liquid crystal display device with a partial display function, comprising:
a pixel array including a plurality of display elements disposed in row and column directions, a plurality of scanning signal lines, each being commonly connected to the display elements disposed in the same row, and a plurality of data signal lines, each being commonly connected to the display elements disposed in the same column;
a scanning signal line drive circuit for selectively activating the scanning signal lines; and
a data signal line drive circuit for driving the data signal lines based on a supplied video signal,
wherein the data signal line drive circuit includes:
a shift register for outputting a sampling signal to each of the data signal lines;
selection circuits each having first and second output terminals to output the sampling signal outputted from the shift register at least from the first output terminal during a normal display mode, and from the second output terminal during a partial display mode;
first sampling portions each sampling the video signal based on the sampling signal outputted from the first output terminal for application to the data signal line; and
second sampling portions each sampling the video signal based on the sampling signal outputted from the second output terminal for application to the data signal line.

2. The liquid crystal display device according to claim 1, wherein the second sampling portions have such a circuit configuration as to be operated at a lower speed than the first sampling portions.

3. The liquid crystal display device according to claim 2,
wherein the first sampling portions each include:
a first buffer portion to which the sampling signal outputted from the first output terminal is inputted; and
a first sampling switch alternating between applying and not applying the video signal to the data signal line based on the sampling signal outputted from the first buffer portion,
wherein the second sampling portions each include:
a second buffer portion to which the sampling signal outputted from the second output terminal is inputted; and
a second sampling switch alternating between applying and not applying the video signal to the data signal line based on the sampling. signal outputted from the second buffer portion,
wherein the second buffer portion has a lower drive capability than the first buffer portion, and
wherein the second sampling switch has a higher on-resistance than the first sampling switch.

4. The liquid crystal display device according to claim 3,
wherein the second buffer portion is configured by transistors with a narrower channel width than those of the first buffer portion, and
wherein the second sampling switch is configured by transistors with a narrower channel width than those of the first sampling switch.

5. The liquid crystal display device according to claim 1, wherein during the normal display mode, the selection circuits each output the sampling signal outputted from the shift register from the first output terminal, but not from the second output terminal.

6. The liquid crystal display device according to claim 1, wherein during the normal display mode, the selection circuits each output the sampling signal outputted from the shift register from both the first and second output terminals.

7. The liquid crystal display device according to claim 1,
wherein the scanning signal line drive circuit switches any scanning signal line to be activated every first line time during the normal display mode, while switching the scanning signal line to be activated every second line time longer than the first line time during a display period of the partial display mode, and
wherein the shift register is operated at first sampling intervals during the normal display mode, and at second sampling intervals longer than the first sampling intervals during the display period of the partial display mode.

8. A method for driving a liquid crystal display device having a pixel array including a plurality of display elements disposed in row and column directions, a plurality of scanning signal lines, each being commonly connected to the display elements disposed in the same row, and a plurality of data signal lines, each being commonly connected to the display elements disposed in the same column, the method comprising the steps of:
selectively activating the scanning signal lines; and
driving the data signal lines based on a supplied video signal,
wherein the step of driving the data signal lines includes the steps of:
generating a sampling signal for each of the data signal lines;
outputting the generated sampling signal at least as a first sampling signal during a normal display mode, and as a second sampling signal during a partial display mode;
sampling the video signal based on the first sampling signal using a first sampling portion for application to the data signal line; and
sampling the video signal based on the second sampling signal using a second sampling portion for application to the data signal line.
